(19) United States
(12) Patent Application Publication
(10) Pub. No.: US 2024/0384057 A1
(43) Pub. Date: Nov. 21, 2024

(54) PREPARATION OF CURED RUBBER PRODUCTS WITH PHYSICALLY DETECTABLE MARKERS TO PROOF THE ORIGIN OF NATURAL RUBBER, USED AS A RAW MATERIAL IN THE MANUFACTURE OF THESE PRODUCTS

(71) Applicants: Continental Reifen Deutschland GmbH, Hannover (DE); CONTITECH AG, Hanover (DE)

(72) Inventors: Hubert HIRSCHLAG, Hannover (DE); Hon Peng TANG, Petaling Jaya (MY); Jens H¿GERMEIER, Hannover (DE)

(21) Appl. No.: 18/688,843

(22) PCT Filed: Sep. 3, 2021
(86) PCT No.: PCT/EP2021/074394

§ 371 Date: Mar. 4, 2024

(51) Int. Cl. C08K 3/22

(52) U.S. Cl. CPC C08K 3/22; C08K 2003/2206; C08K 2003/221; C08K 2003/2244

(57) ABSTRACT

The invention relates to a method for preparing a marked natural rubber from natural rubber latex collected from plants, or for preparing a marked cured rubber product. wherein a marker comprising one or more metal ion types in the form of metal salts and/or metal oxides is blended into natural rubber latex, natural rubber or coagulated natural rubber, to obtain the marked natural rubber, wherein, in case of preparing the marked cured rubber product, the process further comprises preparing a rubber compound comprising the marked natural rubber and curing and shaping the rubber compound.

The invention relates to a method for preparing a marked natural rubber from a collected natural rubber and for preparing a marked cured rubber product with the marked natural rubber obtained by means of a marker comprising one or more metal ion types in the form of metal salts or metal oxides, the marked natural rubber and the marked cured rubber obtainable by the method and the use of the one or more metal ion types of metal salts or metal oxides as a marker in natural rubbers or cured rubber products.

It is known that substances at low concentration levels can be used to mark a material to identify the origin of the material. Some of these technologies describe the usage of organic molecules that can be detected either via fluorescent properties directly or by enhancing the content of these marking materials, e.g. via polymerase chain reaction in the case of DNA markers.

WO2021/009757 A1 describes the use of complexed metal ions for the use of marking polymeric substances and detection of the metal ions via x-ray fluorescence to trace the origin in the value chain of these polymers.

DE102019122010 A1 relates to the use of organic molecules for marking objects and detection via fluorescence after excitation with UV/Vis or IR radiation.

EP2356636A1 describes the labelling of objects with fluorescent markers in a carrier to proof authenticity by adding a large number of different markers into one object.

K. Regel, “Winzige Marker schützen vor Plagiatoren” in K-PROFI, issue 6/2020, pages 22 to 25, discusses UV/Vis fluorescence detection on marker substances in foils.

The described substances are complex mixtures or chemicals that are connected to high cost and/or more importantly cannot be used in a large scale in an environment that is sensitive to safety and health related restrictions of the used marker materials.

The production process of natural rubber involves several processing and aging steps that can wash out or alter possible markers. Also, in the case of cured rubber products, markers are exposed to complex chemical reactions and high temperatures in the mixing and curing process. Therefore, known marker systems do not fulfil the requirements of having a very low toxicity profile and are stable enough to remain unchanged during the production process of a tire.

Natural rubber is an agricultural product commonly harvested from trees. Frequently, harvesting conditions are difficult and not always according to good and sustainable agricultural practices. Due to the location of many farms in not easily accessible areas, the supply chain of natural rubber is notoriously in-transparent. Big efforts are made to increase the transparency of the supply chain and proof the origin of natural rubber that is used to manufacture rubber products. So far, no solution exists that could physically proof the origin of rubber.

The object of the invention is to provide marked natural rubber and marked cured products with which physical proof on the origin of natural rubber in raw materials of the natural rubber used for preparing cured rubber products and also in the cured rubber products prepared therefrom is possible. The marker system for marking the natural rubber should be of very low toxicity and stable enough to remain unchanged during the production process of the natural rubber and also of the cured rubber article such as tires. The marker should be inexpensive, simple and easy to apply. In addition, the detection of the marker should be easy and accurate.

It has been surprisingly found that this object can be achieved by using metal ions or simple combinations of metal ions in the form of salts or oxides, which can be soluble or not soluble, as marking systems in natural rubbers and cured rubber products derived therefrom.

Accordingly, the invention relates to a method for preparing a marked natural rubber, which is in solid form or in form of a concentrated latex, from natural rubber latex collected from plants, or for preparing a marked cured rubber product, wherein the method comprises

preparing the natural rubber from the collected natural rubber latex,
wherein a marker comprising one or more metal ion types in the form of metal salts and/or metal oxides is blended into
a natural rubber latex or
the natural rubber or
a coagulated natural rubber as intermediate stage formed during the preparation of the natural rubber from the collected natural rubber latex, to obtain the marked natural rubber,
   wherein, in case of preparing the marked cured rubber product, the process further comprises
   preparing a rubber compound comprising the marked natural rubber and curing and shaping the rubber compound to obtain the cured rubber product.

The invention provides a system of chemical markers that can be applied easily in an environmentally sensitive environment at low cost and stable enough to remain unchanged in the production process of a natural rubber, such as a natural rubber bale or sheet, and in the production process of a cured rubber product such as a tire. The experiments show that the marking withstands the rubber mixing and curing processes as well as processing in natural rubber preparation (coagulation/aging/homogenization/washing/drying). With this technology it is possible to give physical proof on the origin of natural rubber, because the marking can be made specific to the harvested region and can be tested in the product.

The combination of simple metal salts and/or metal oxide, which can be detected e.g. via x-ray fluorescence, with the possibility to apply them close to the harvesting operation of natural rubber gives transparency to the origin of the natural rubber. The used chemical system is environmentally safe, low cost and can withstand the processing conditions of manufacturing natural rubber and cured rubber products. With these features of the disclosed solution it is possible to have full transparency of the complete value chain of an agricultural commodity, natural rubber, from the tree to the final rubber product. Further advantages of this method is that x-ray fluorescent materials can be detected in conventional rubber compounds that use Carbon Black as a filler. The use of Carbon Black normally prevents detection of IR or UV-Vis or UV signals.

The solution fulfils the requirements and overcomes the problems described above including the marking of natural rubber directly in the field or close vicinity to where the rubber is being harvested.

This technology is also suitable to protect cured rubber goods against counterfeiting.

The marking is fixed to the natural rubber material and persists during processing of natural rubber and also can withstand the conditions during the manufacture of cured rubber products. Detection of the marker is easily possible, preferably by a mobile x-ray fluorescence detector as they are standard in the industry.

It was surprising that the metal ions added in form of salts or oxides are firmly bound within the natural rubber so that they are substantially not washed out during the conventional processing for preparing natural rubber.

Without wishing to be bound to any theory, it is assumed that the metal ions are fixed within the molecular structure of the natural rubber. While the fixing mechanism is not known the metal ions are presumably not contained in form of the salts or oxides which have been added.

In the following, the invention will be described in detail.

The inventive method concerns the preparation of a marked natural rubber, which is in solid form or in form of a concentrated latex, from natural rubber latex collected from plants, or for preparing a marked cured rubber product.

The method comprises preparing the natural rubber from the collected natural rubber latex. The process of preparing natural rubber from collected natural rubber latex is generally known by the skilled person and widely used in the world to obtain natural rubber as a raw material. A number of variants of this process are known, which are all suitable for the inventive method. An overview of the various processes can be found e.g. in Ullmann's Encyclopedia of Industrial Chemistry, 5th edition, vol. A23, 1993, pages 225 to 237, under the section “Rubber, 2. Natural”, which is included by reference.

Natural rubber is produced by a number of plants in form of a natural rubber latex which is collected from the plants. The collection is also called extraction or harvest. The largest part of natural rubber latex collected in the world is collected from the plant Hevea brasiliensis which is a tree also called rubber tree. Other plants producing natural rubber are e.g. ficus elastic, guayule, taraxacum, esp. taraxacum koksaghyz, and tapioca bush.

A method to prepare a natural rubber suitable for further processing from the collected natural rubber into a suitable form is concentrating the collected natural rubber latex to form a concentrated natural rubber latex. It has a higher solid content than the collected latex. Conventional methods for concentrating the collected natural rubber latex are centrifugation, the creaming method and evaporation of water.

In other methods a solid form of the natural rubber is prepared from the collected natural rubber latex, in particular by a coagulation process. In this process it is not necessary to concentrate the collected natural rubber latex before coagulation. It may be suitable to dilute the collected natural rubber latex before coagulating it. In order to separate the natural rubber from the latex by coagulation precipitating agents such as acids, e.g. formic or acetic acids, may be added. The coagulated natural rubber is to be processed further quickly. Major processes to stabilize the coagulated natural rubber are the smoked sheet process and the crepe rubber process. The resulting natural rubber is solid and generally in form of sheets or bales.

According to preferred embodiments, the marked natural rubber, which is in solid form or in form of a concentrated latex and prepared from the collected natural rubber latex, is in the form of a bale, a sheet or a concentrated natural rubber latex, wherein a natural rubber bale or sheet is preferred.

According to the inventive method, a marker comprising one or more metal ion types in the form of metal salts or metal oxides is blended into a natural rubber latex, a coagulated natural rubber formed as intermediate stage during the preparation of the natural rubber from the collected natural rubber latex, or the natural rubber in order to obtain the marked natural rubber.

The intermediate stage may be a coagulated natural rubber obtained after coagulation as described above. A natural rubber latex as used herein includes the collected natural rubber latex as well as any natural rubber latex which is obtained by treatment of the collected natural rubber latex such as concentration, dilution or possible addition of substances, unless otherwise stated.

In a particular preferred embodiment, the preparation of the marked natural rubber comprises coagulating the natural rubber latex to form a coagulated natural rubber as an intermediate stage and processing the coagulated natural rubber to form a solid natural rubber, in particular a natural rubber bale or sheet, wherein the marker is blended into the natural rubber latex or the coagulated natural rubber. In general, the coagulated natural rubber is separated from the liquid supernatant called serum for further processing.

The natural rubber latex which is coagulated may be the collected natural rubber latex or a treated form thereof, e.g. by concentration, dilution or optional addition of substances.

When the marker is added to the coagulated natural rubber separated from the serum, it is appropriate to blend the marker as soon as possible after generation of the coagulated natural rubber, preferably immediately up to 72 hours after coagulation. More preferred immediately up to 24 hours after coagulation.

Thus, the blending of the marker natural rubber can be done directly in the natural rubber latex or in the preferably recently coagulated natural rubber latex. This is advantageous since a sufficiently homogenous distribution of the marker in the natural rubber is easily achieved as required to appropriately detect the marker metal ions by analysis, e.g. x-ray fluorescence (XRF).

The processing of the coagulated natural rubber to form a solid natural rubber, in particular a natural rubber bale or sheet, generally includes stabilization and drying of the coagulated natural rubber. As mentioned above common processes for processing are the smoked sheet process and the crepe rubber process after which the natural rubber is obtained in form of a bale or a sheet.

In a further preferred embodiment, the preparation of the marked natural rubber comprises concentrating the collected natural rubber latex to form the concentrated natural rubber latex, wherein the marker is blended into the natural rubber latex before, during or after concentration. Also in this case, an appropriate homogeneity of marker distribution within the natural rubber is easily achieved.

In a further possible embodiment, preparation of the marked natural rubber comprises blending the marker into the solid natural rubber, wherein the solid natural rubber is preferably comminuted before the marker is added. This embodiment is less preferred as compared to the two embodiments described above, since the homogenous blending of the marker into the rubber is more elaborate. Moreover, the physical proof on the origin of natural rubber begins only at this stage, which is usually of minor value, if at all.

The blending of the marker into the natural rubber latex including the collected natural rubber latex generally comprises adding the marker to the latex and mixing, e.g. by stirring.

The blending of the marker into the coagulated natural rubber latex generally comprises adding the marker to the coagulated natural rubber. The marker applied on the coagulate which has a foam like structure migrates into the coagulated natural rubber. The further processing of the coagulated natural rubber e.g. into sheets or bales supports the distribution of the marker. As a result, the solid natural rubber, in particular the marked natural rubber sheet or bale shows an appropriate homogenous distribution of the marker.

The blending of the marker into a natural rubber bale or sheet generally comprises comminuting the bale or sheet into pieces and adding the marker to the pieces and mixing, e.g. by means of a roll mill or a kneader.

As mentioned, the marker used in the inventive method comprises one or more metal ion types in the form of metal salts and/or metal oxides. These marking systems are simple combinations of metal ions or even a single metal ion in the form of salts and/or oxides. The metal salts and/or metal oxides used may be soluble or not soluble in water. The degree of solubility appears to have no significant impact on the performance of the marker.

In principle, the metal ion types can be selected from any metal. Suitable metal ion types can be selected inter alia by fulfilling one or more of the following criteria:
a low toxicity profile
good detection sensitivity with easily detectable signals for the analysis method applied, e.g. x-ray fluorescence
good fixing capability to the natural rubber
low price.

Accordingly, the one or more metal ion types of the marker are preferably selected from the group consisting of K, Ca, Ba, Ti, Fe, Se, Sc, Co, Hf, Ta, Mo, W, Re, Mn, Cr, Ni, Cu, Zn, Rb, Sr, Y, Zr and Nb.

The one or more metal ion types of the marker are more preferably selected from the group consisting of Ba, Ti, Cr, Ni, Hf, Ta, Mo, W, Zn, Sr, Y, Zr and Nb.

The one or more metal ion types of the marker are still more preferably selected from the group consisting of Ti, Zn, Sr, Y, Zr, Hf, Ta and Nb, wherein the one or more metal ions are preferably selected from Sr, Y, Zr and Nb.

The counter ion of the metal salt used has no significant importance on the performance of the marker. Thus, any counter ion may be suitable and easily available and relatively inexpensive salts may be preferred. Examples of suitable metal salts, in particular metal salts of the metal ions specified above, are halides, in particular chlorides, sulfates, carbonates or phosphates. Apart from the metal salts, metal oxides are also suitable, in particular metal salts of the metal ions specified above. The metal salt and metal oxide also include hydrates of the metal salt or metal oxide, respectively.

Specific examples of metal salts and metal oxides suitable for the marker are yttrium chlorides, such as YCl₃*6H₂O, strontium chlorides, such as SrCl₂*6H₂O, niobium oxides, such as Nb₂O₅, zirconium dioxide (ZrO2), zinc oxides (ZnO), tantalum oxides (Ta₂O₅), hafnium oxides (HfO₂).

The metal ion types of the marker may in principle correspond to metal ion types contained in the natural rubber and/or in the cured rubber product which are from other sources. Low concentrations or trace amounts of the same metal types from other sources may be no significant problem. However, relatively high concentrations of the same metal ion types from other sources may impede accuracy of the detection of the metal ions from the marker. This may require to use higher amounts of the marker to compensate the lowered sensitivity which is not desirable, inter alia for economic and environmental reasons. Therefore, the selection of the metal ion types of the marker should consider the ingredients contained in the natural rubber and in particular in the cured rubber product.

According to a preferred embodiment, the method of the invention is implemented such that, if one or more metal ion containing additives are added during the preparation of the natural rubber to be marked, the one or more metal ion types in the marker are different from the metal ion type or types contained in said additive(s).

According to a further particular preferred embodiment, the method of the invention is implemented such that, if one or more metal ion containing additives are added to the rubber compound comprising the marked natural rubber, the one or more metal ion types in the marker are different from the metal ion type or types contained in said additive(s).

Thus, the selection of the metal ion types of the marker may depend on the particular natural rubber to be marked or the particular cured rubber product derived therefrom. For instance, rubber compounds for tires often include ZnO as an additive. Accordingly, for such applications the use of a zinc salt or zinc oxide is less preferred. On the other hand, rubber compounds based on concentrated natural rubber latex usually do not contain zinc additives. In this case, zinc salts or oxides are suitable for the marker.

The marker used in the invention comprises one or more metal ion types in the form of metal salts and/or metal oxides. Distinct information to be identified such as the particular origin of the collected natural rubber latex can be represented in the marker by the particular metal ion type(s) and/or the concentration thereof in the marker used.

The higher the number of metal ion types included in the marker, the more different information can be represented. On the other hand, a high number of different metal ion types in the marker increases complexity of the system.

It is preferred that the marker comprises 1 to 6, preferably 1 to 4, more preferably 1, 2 or 3, most preferably 2 types of metal ions. Using 1, 2 or 3 metal ion types in the marker is usually sufficient to represent the various information to be identified. The use of two metal ion types in the marker has been shown to be very effective.

When two or more metal ion types are included in the marker, the weight ratio between the metal ion types may vary. Of course, the amount of each metal ion type should be adjusted so that accurate detection is possible.

The total amount of the one or more metal ions in the marker blended into the natural rubber latex, the coagulated natural rubber product or the natural rubber is preferably in the range of 1 to 1000, preferably 5 to 300, more preferably 10 to 100, still more preferably 10 to 50 ppm by weight per dry weight of the natural rubber.

The amount of each metal ion of the one or more metal ions in the marker blended into the natural rubber latex, the coagulated natural rubber product or the natural rubber is preferably in the range of 1 to 500, preferably 2 to 150, more preferably 5 to 50, still more preferably 5 to 25 ppm by weight per dry weight of the natural rubber.

The one or more metal salts and/or metal oxides included in the marker can be in dry form or dissolved or dispersed in a solvent. The solvent may be water, one or more organic solvents such as alcohols, or a combination thereof. If a solvent is used, a preferred solvent is water.

If the marker comprises more than one metal salt and/or metal oxide, the metal salt(s) and/or metal oxide(s) can be added separately or as a mixture.

Any analysis method suitable for detecting the metal ions of the marker can be used. The analysis method should be suitable to detect the metal ion type and its concentration for each metal ion type contained.

The type and concentration of each of the one or more metal ions of the marker in the marked natural rubber or in the marked cured rubber product is preferably detected by x-ray fluorescence (XRF), optical emission spectroscopy (OES), inductively coupled plasma optical emission spectrometry (ICP-OES), or atomic absorption spectroscopy (AAS).

Detection by means of XRF is most preferred. Commercial handheld XRF devices are available and widely used. With such handheld devices a fast detection can be achieved, e.g. approx. 30 s per measurement. The measurement can be performed on the marked natural rubber or the marked cured rubber product.

The method of the invention for preparing a marked natural rubber has been described above. The marked natural rubber is an uncured natural rubber.

In the alternative embodiment of the method according to the invention a marked cured rubber product is prepared using the marked natural rubber prepared. In this case the method further comprises preparing a rubber compound comprising the marked natural rubber and curing and shaping the rubber compound to obtain the marked cured rubber product.

The preparation of the marked cured rubber product corresponds to the conventional preparation of cured rubber products with which the skilled person is well familiar, except that the marked natural rubber prepared according to the inventive method is used instead of a conventional natural rubber.

The marked natural rubber of the invention is compounded into a rubber compound which correspond to the conventional rubber compounds in each other aspect. Thus, the rubber compound comprising the marked natural rubber usually further comprises one or more rubbers different from the marked natural rubber and/or one or more additives common in this technical field. In a preferred embodiment, the rubber compound can be assembled with one or more other components of the cured rubber product before curing.

The marked cured rubber product obtained by the method according to the invention may be for instance a technical rubber good, a tire, such as vehicle tire or bicycle tire, a belt, such as drive belt or conveyor belt, a tube, a damper such as vibration damper or impact damper, or a part thereof such as a tire tread. Another marked cured rubber product which is obtainable are rubber gloves. The tire and tire treads are preferred cured rubber products. The tire is preferably a pneumatic tire.

The invention is also related to a marked natural rubber, which is obtainable by the method according to the invention as described above. The marked natural rubber of the invention is in solid form or in form of a concentrated natural rubber latex. The marked natural rubber is preferably in the form of a bale, a sheet or a concentrated natural rubber latex, wherein a natural rubber bale or sheet is preferred.

As described above, the precise molecular structure or configuration of the metal ions of the marker in the marked natural rubber of the invention is not clear, and it is assumed that there is a particular interaction between the metal ions of the marker and the natural rubber so that the marked rubber is not considered to be a simple mixture of the metal salts and/or metal oxides of the marker and the rubber.

The invention is also related to a marked cured rubber product, which is obtainable by the method according to the invention as described above. The marked cured rubber product is preferably a technical rubber product, a tire, such as vehicle tire or bicycle tire, a belt, a such as drive belt or conveyor belt, a tube, rubber gloves, a damper such as vibration damper or impact damper, or a part thereof such as a tire tread. The tire is a preferred cured rubber product and is preferably a pneumatic tire or a tire tread.

The invention is also related to the use of one or more metal ion types in the form of metal salts and/or metal oxides as a marker in a natural rubber, which is in solid form or in form of a concentrated latex, or in a cured rubber product. The cured rubber product is generally prepared from a rubber compound comprising the marked natural rubber of the invention. In particular, the cured rubber product comprises the inventive marked natural rubber which has been cured.

The use according to the invention is preferably according to the process of the invention as described above.

The invention will now be further explained by way of examples, which are for illustrative purposes only without limiting the scope of the invention

### EXAMPLES

### Protocol I—Marking of High Viscosity NR (NR=Natural Rubber)

### Materials:

1. CV-60 (natural rubber sheet)
2. Marking system A: YCl₃*6H2O (78 ppm)
   SrCl₂*6H₂O (78 ppm)
3. Marking system B: Nb₂O₅ (78 ppm)
   ZrO₂ (78 ppm)

CV means constant viscosity. 60 refers to approx. 60 mooney units.

Alternatively, also TSR (technical specified rubber) can be used, e.g. SMR 10 or SIR 10. SMR is a type of TSR and stands for standard Malaysian rubber. SIR stands for standard Indonesian rubber.

### Experiment Description:

Initially, a roll mill unit was cleaned with CV-60 and was processed for a period of at least for 20 minutes in order to make sure that no markers could be derived from contaminating impurities. This was verified.

Thereafter, 1 kg of rubber CV-60 was inserted into the roll mill unit and the processes started by “breaking” the sample. After at least 10 min of rubber processing, the rubber was heated by friction on the rolls to a temperature between 60-80° C. (without any further heating from the machinery) and the rubber was made into a single piece. Markers were added at this stage wherein in an experiment marking system A was used, and in another experiment marking system B was used).

For better embedding of markers a gap of 0 cm was set on the roll mill. This way, the high shear forces result in a better mixing of the marker. Processing was continued for a period of 10 minutes. 3 samples from different locations of the sheet were cut. Each piece was measured for the presence of the marker in 3 locations-total 9 measurements. The process was repeated until the homogeneity of the markers was good and did not improve (less than 10%). Thereby, homogenous distribution of the markers was achieved.

### Protocol II-Marking of Liquid NR

### Materials:

1. Liquid rubber marking was performed using liquid latex-ammonia solution.
2. Marking system A: YCl₃*6H₂O
   SrCl₂*6H₂O
3. Marking system B: Nb₂O₅
   ZrO₂

### Experiment Description:

Liquid rubber marking was performed using liquid latex-ammonia solution. The two marking systems used differed in their solubility in water. The first system was based on water-soluble markers—YCl₃ and SrCl₂. The markers were initially dried in a vacuum oven at ˜40° C. for 24 hours due to their hygroscopic nature. Then, the dried markers were dissolved in 60 g deionized water. The aqueous marker solution was slowly dripped into 850 g liquid rubber, resulting in a final marker concentration per each metal salt of 0.0078 weight-% per dry weight of natural rubber. The mixture was thoroughly stirred to form a homogenized solution.

The second marking system was based on water-insoluble markers—ZrO₂ and Nb₂O₅. The markers were added in their powder form into 850 g liquid rubber, resulting in a final marker concentration per each metal salt of 0.0078 weight-% per dry weight of natural rubber. The materials were thoroughly stirred to form a homogenized mixture.

For both marking systems, the solution was cast in a square mold to form a thin layer (˜0.5 cm). The solution was left to dry (ammonia evaporation) for 72 hours under normal conditions. 72 hours later, a flat sheet of marked rubber was obtained.

### Protocol I—Continuation of Protocol I Preparation of Marked High Viscosity Rubber (Preparation of Marked Natural Rubber Product).

### Materials:

1. Rubber sample with embedded marker system A, prepared according to Protocol I—Marking of high viscosity NR above
2. Rubber sample with embedded marker system B, prepared according to Protocol I—Marking of high viscosity NR above
3. Unmarked rubber bale

The marked rubber sample was blended with unmarked NR bale to produce diluted rubber sheet with marker system at 20%, 50% and 100% by mass percentage (w/w %) at 800 g, this blending step was performed in 2 roll-mill unit for 5 mins. After each of the blending steps, the 2 roll-mill was cleaned thoroughly with CV-60 rubber for a period of 5 minutes to avoid cross-contamination from previous blending steps. Thereafter, the individual mixing was conducted in an internal mixer using internal reference compound and cured at 160° C. for 15 mins. Mixing recipe as per following:

| Materials | PHR |
|---|---|
| Natural rubber | 100 |
| Carbon black N121 | 48.5 |
| DTPD | 1.0 |
| 6PPD | 1.5 |
| TMQ | 1.0 |
| Paraffinic wax | 2.5 |
| Zinc oxide | 3.0 |
| Stearic acid | 2.0 |
| TBBS | 1.0 |
| Soluble Sulfur | 1.65 |

PHR: Parts per hundred Parts of rubber by weight
DTPD: N,N′-ditolyl-p-phenylendiamine
6PPD: N-phenyl-N′-(1,3-dimethylbutyl)-p-phenylendiamin
TMQ: 2,2,4-trimethyl-1,2-dihydroquinoline,
TBBS: N-tert.-butyl-2-benzothiazylsulfenamide

The cured rubber discs were cut into internal standard ring size, with a thickness of 6 mm and tensile testing were performed to check the impact of marker particles towards compound physical properties. No significant impact was observed in comparison to the unmarked rubber disk and the marked rubber disks at all marker concentration levels (20%, 50% and 100%), for both marker system A and marker system B.

| | Density | Tensile | EB | M100 | M200 | M300 |
|---|---|---|---|---|---|---|
| Sample ID | (g/cm3) | (Mpa) | (%) | (Mpa) | (Mpa) | (Mpa) |
| Unmarked Disk 1 | 1.0941 | 24.48 | 528 | 2.21 | 6.55 | 12.67 |
| Unmarked Disk 2 | 1.0974 | 24.47 | 507 | 2.67 | 7.67 | 14.09 |
| 20% Marker A | 1.0946 | 23.93 | 502 | 2.52 | 7.35 | 13.65 |
| 50% Marker A | 1.0942 | 25.47 | 525 | 2.63 | 7.60 | 13.99 |
| 100% Marker A | 1.0993 | 24.36 | 513 | 2.64 | 7.51 | 13.81 |
| 20% Marker B | 1.1000 | 23.80 | 481 | 2.80 | 8.06 | 14.67 |
| 50% Marker B | 1.1001 | 24.87 | 509 | 2.62 | 7.69 | 14.22 |
| 100% Marker B | 1.0992 | 24.02 | 515 | 2.74 | 7.55 | 13.57 |

According to Protocol I, marking was effected by blending the marker systems into natural rubber. Thus, it could be verified independently that the marking withstands mixing and curing processes used in cured rubber preparation. It is also suitable to obtain specimens for testing the accuracy of analytical determination. For identification purposes, this embodiment is of minor importance as it does not include information on the origin of the natural rubber.

No effects on physical properties could be observed. Marked rubber compound discs exhibit the same physical properties as non-marked rubber discs, as would be expected by the very low concentrations of the added marker substances.

### Protocol II—Continuation of Protocol II Preparation of Marked Liquid NR Rubber (Preparation of Marked Natural Rubber Product)

### Materials:

1. Rubber sample with embedded marker system A, prepared according to Protocol II—Liquid Marking of liquid NR above.
2. Rubber sample with embedded marker system B, prepared according to Protocol II—Liquid Marking of liquid NR above.
3. 0.1% lime solution—Ca(OH)₂.

### Experiment Description:

The rubber sheet with embedded marker system is going through a NR production process simulation in lab environment. Rubber processing with different marker systems was done separately and performed in different days.

150 g marked rubber sample was weighted and cut into smaller pieces in size of approximately 30×30 mm. The cut rubber pieces were placed in a mesh basket and rinsed through with running tap water and stirred manually for 5 minutes. These steps were repeated for 3 times until the rubber crumbs size achieved to approximately 10 mm. The wet rubber crumbs were collected in a mesh basket and shook manually for 1 minute to remove the excessive water on the surface. Thereafter, the rubber crumbs were passed through the 2 roll-mill unit at the nip setting of 5 mm for 7 times and rinsed with tap water in between the steps. Final rubber crumbs size reduction was done by manual scissors cut into the size of 3-5 mm and then immersed in a tray contained of 0.1% lime solution and stirred constantly for 5 minutes. The rubber crumbs were then removed from the tray and left air-dried in a controlled room temperature at 25° C. for more than 12 hours. After the air-drying process, the rubber crumbs were placed into the lab oven at 130° C. for 1 hour. The final step was to sheet out the dried rubber by passing through the 2 roll-mill unit at room temperature, with the nip setting at 0.1 mm. The rubber sheets were in average of a thickness of 2 mm.

### Protocol III—Detection Test of Marker in Natural Rubber

Materials:

| Sample No | Label | Description |
|---|---|---|
| BT1 | BT1-1 | 4 kg piece of NR bale unmarked |
| BT1 | BT1-2 | 4 kg piece of NR bale unmarked |
| BTA2 | BTA2-1, BTA2-2, | 3 kg pieces (1 kg each) of NR bale |
| | BTA3-3 | marked with marker system A* |
| BTB2 | BTB2-1, BTB2-2, | 3 kg pieces (1 kg each) of NR bale |
| | BTB3-3 | marked with marker system B* |
| BTR2 | BTR2 | 1 kg piece of unmarked processed |
| | | NR bale |

*prepared according to Protocol I - Marking of high viscosity NR

For the detection of the marker in the specimen disks (metal ion type and concentration) a commercial handheld XRF device was used.

### Calibration:

The following specimen discs (dimension: 52 mm×6 mm) were formed from the above materials or mixtures thereof and cured according to standard curing conditions, e.g. 160° C., 20 min.

| Sample No. | Label | Description |
|---|---|---|
| BTDisk1 | BTDisk1 | 3 disks of unmarked material |
| BTDisk2 | BTDisk2 | 3 disks of unmarked processed material |
| BTDisk3 | BTDisk3 - 20% | 3 disks with material marked A 20% |
| | marker A | |
| BTDisk4 | BTDisk4 - 50% | 3 disks with material marked A 50% |
| | marker A | |
| BTDisk5 | BTDisk5 - 100% | 3 disks with material marked A 100% |
| | marker A | |
| BTDisk6 | BTDisk6 - 20% | 3 disks with material marked B 20% |
| | marker B | |
| BTDisk7 | BTDisk7 - 50% | 3 disks with material marked B 50% |
| | marker B | |
| BTDisk8 | BTDisk8 - 100% | 3 disks with material marked B 100% |
| | marker B | |

The specimen discs prepared were sent as reference samples to an external company together with information on the composition of the specimens in order to prepare a calibration curve.

### Blind Test:

The following specimen discs (dimension: 52 mm×6 mm) were formed from the above materials or mixtures thereof or other material and cured according to standard curing conditions, e.g. 160° C., 20 min.

| Sample No. | Label | Description |
|---|---|---|
| BTDisk9 | BTDisk9 | A (10%) |
| BTDisk10 | BTDisk10 | B (50%) |
| BTDisk11 | BTDisk11 | rubber sample (diff. compound), |
| | | unmarked |
| BTDisk12 | BTDisk12 | A (100%) |
| BTDisk13 | BTDisk13 | NR sample (diff. compound), |
| | | unmarked |
| BTDisk14 | BTDisk14 | B (100%) |
| BTDisk15 | BTDisk15 | A (20%) |
| BTDisk16 | BTDisk16 | A (50%) |
| BTDisk17 | BTDisk17 | B (10%) |
| BTDisk18 | BTDisk18 | B (20%) |
| BTDisk19 | BTDisk19 | Unmarked processed material |
| | | (BTR2) |

For each sample one disk was sent to the external company as a “blind test” (no information on the composition given). The external company was requested to detect whether the samples are marked with A or marked with B or not marked and to determine the concentration in the marked samples.

As a result, the external company could correctly assign all blind samples to the correct composition with respect to samples marked with A or marked with B or not marked as well as the with respect to the concentration range in the marked samples. This shows the high accuracy of the method for marking natural rubber specimens.

In this way it was confirmed that the marker substance withstands the processing conditions during the preparation of natural rubber sheets as well as the curing and mixing processes in the preparation of rubber compound discs.

### Protocol—IV

A natural rubber latex was treated with a combination of strontium chloride and yttrium chloride (marking system A described above, concentration approx. 100 ppm of each metal salt per dried rubber). The latex was coagulated, aged, processed and dried in a laboratory, according to standard industrial conditions to produce natural rubber sheets. From these sheets, standard tire tread compounds where mixed by adding carbon black, zinc oxide, sulfur, antioxidants, accelerators and other standard tire compound ingredients.

Also, in separate trials, the rubber sheets were “diluted” with non-marked natural rubber to 50% or 10%. Tire tread compound was mixed from these samples, as well. The detection of the marker system was done via x-ray fluorescence detection on small rubber discs. The concentration of the marked natural rubber could easily be identified. Detection was readily possible.

### Protocol V

A marker system of zirconium-and niobium oxides (marking system B described above, concentration of approx. 100 ppm per weight of each metal salt per dried rubber by weight) was added to already precipitated natural rubber lumps. The rubber lumps were aged, processed and dried in a laboratory, according to standard industrial conditions to produce natural rubber sheets. From these sheets, standard tire tread compounds where mixed by adding carbon black, zinc oxide, sulfur, antioxidants, accelerators and other standard tire compound ingredients.

Also, in separate trials, the rubber sheets were “diluted” with non-marked natural rubber to 50% or 10%. Tire tread compound was mixed from these samples, as well. The detection of the marker system was done via x-ray fluorescence detection on small rubber discs. The concentration of the marked natural rubber could easily be identified. Detection was readily possible.

1. A method for preparing a marked natural rubber, which is in solid form or in form of a concentrated latex, from natural rubber latex collected from plants, or for preparing a marked cured rubber product,
wherein the process comprises
preparing the natural rubber from the collected natural rubber latex,
wherein a marker comprising one or more metal ion types in the form of metal salts and/or metal oxides is blended into
a natural rubber latex or
the natural rubber or
a coagulated natural rubber formed as intermediate stage during the preparation of the natural rubber from the collected natural rubber latex,
to obtain the marked natural rubber,
wherein, in case of preparing the marked cured rubber product, the process further comprises
preparing a rubber compound comprising the marked natural rubber and curing and shaping the rubber compound to obtain the cured rubber product.

2. The method of claim 1, wherein
the marked natural rubber is in the form of a bale, a sheet or a concentrated natural rubber latex, wherein a natural rubber bale or sheet is preferred.

3. The method of claim 1, wherein
the preparation of the marked natural rubber comprises coagulating the natural rubber latex to form a coagulated natural rubber and processing the coagulated natural rubber to form a natural rubber bale or sheet, wherein the marker is blended into the natural rubber latex or the coagulated natural rubber,
the preparation of the marked natural rubber comprises concentrating the collected natural rubber latex to form the concentrated natural rubber latex, wherein the marker is blended into the natural rubber latex before, during or after concentration, or
the preparation of the marked natural rubber comprises blending the marker into the solid natural rubber, wherein the solid natural rubber is preferably comminuted before the marker is added.

4. The method of claim 1, wherein the one or more metal ion types of the marker are selected from the group consisting of K, Ca, Ba, Ti, Fe, Se, Sc, Co, Mo, Hf, Ta, W, Re, Mn, Cr, Ni, Cu, Zn, Rb, Sr, Y, Zr and Nb.

5. The method of claim 1, wherein the one or more metal ion types of the marker are selected from the group consisting of Ba, Ti, Cr, Ni, Zn, Sr, Y, Zr, Hf, Ta and Nb.

6. The method of claim 1, wherein the one or more metal ion types of the marker are selected from the group consisting of Ti, Zn, Sr, Y, Zr, Hf, Ta and Nb.

7. The method of claim 1, wherein the marker comprises 1 to 6.

8. The method of claim 1, wherein the total amount of the one or more metal ions in the marker blended into the natural rubber latex, the coagulated natural rubber or the natural rubber is in the range of 1 to 1000 ppm by weight per dry weight of the natural rubber, and/or wherein the amount of each metal ion of the one or more metal ions in the marker blended into the natural rubber latex, the coagulated natural rubber product or the natural rubber is in the range of 1 to 500 ppm by weight per dry weight of the natural rubber.

9. The method of claim 1, wherein
if one or more metal ion containing additives are added during the preparation of the natural rubber to be marked, the one or more metal ion types in the marker are different from the metal ion type or types contained in said additive(s), and/or
if one or more metal ion containing additives are added to the rubber compound comprising the marked natural rubber, the one or more metal ion types in the marker are different from the metal ion type or types contained in said additive(s).

10. The method of claim 1, wherein the one or more metal salts and/or metal oxides of the marker are in dry form or dissolved or dispersed in a solvent, preferably water, wherein in the case of more than one metal salt and/or metal oxide, the metal salt(s) and/or metal oxide(s) can be added separately or as a mixture.

11. The method of claim 1, wherein the type and concentration of each of the one or more metal ions of the marker in the marked natural rubber or in the marked cured rubber product is detectable by x-ray fluorescence (XRF), optical emission spectroscopy (OES), inductively coupled plasma optical emission spectrometry (ICP-OES), or atomic absorption spectroscopy (AAS).

12. The method of claim 1, wherein
blending of the marker into the natural rubber latex comprises adding the marker to the latex and mixing,
blending of the marker into the coagulated natural rubber latex comprises adding the marker to the coagulated natural rubber, whereby the marker migrates into the coagulated natural rubber,
blending of the marker into the solid natural rubber, which is a natural rubber bale or sheet, comprises comminuting the bale or sheet into pieces and adding the marker to the pieces and mixing by means of a roll mill or a kneader.

13. The method of claim 1, wherein
the rubber compound comprising the marked natural rubber further comprises one or more rubbers different from the marked natural rubber and/or one or more additives, and/or
the rubber compound is assembled with one or more other components of the cured rubber product before curing.

14. The method of claim 1, wherein the marked cured rubber product is a technical rubber good, especially a tire, such as vehicle tire or bicycle tire, a belt, such as drive belt or conveyor belt, elastomeric coatings of fabrics based on natural rubber, shoe materials not limited to but including the sole, a tube, rubber based hoses, rubber gloves, rubber condoms, a dampener such as vibration dampener or impact dampener, sealings for couplings, rubber based building sealing materials and dampeners, industrial and building vibration dampeners, rail track dampeners, ground mats, or a part thereof such as a tire tread.

15. A marked natural rubber, which is in solid form or in form of a concentrated latex, obtainable by a method according to claim 1.

16. A marked cured rubber product, obtainable by a method according to claim 1, wherein the marked cured rubber product is preferably a technical rubber product, especially a tire, such as vehicle tire or bicycle tire, a belt, such as drive belt or conveyor belt, elastomeric coatings of fabrics based on natural rubber, shoe materials not limited to but including the sole, a tube, rubber based hoses, rubber gloves, rubber condoms, a dampener such as vibration dampener or impact dampener, sealings for couplings, rubber based building sealing materials and dampeners, industrial and building vibration dampeners, rail track dampeners, ground mats, or a part thereof such as a tire tread.

17. (canceled)

18. (canceled)

19. The method of claim 1, wherein the one or more metal ion types of the marker are selected from Sr, Y, Zr and Nb.

20. The method of claim 1, wherein the marker comprises 2 types of metal ions.

21. The method of claim 1, wherein the total amount of the one or more metal ions in the marker blended into the natural rubber latex, the coagulated natural rubber or the natural rubber is in the range of 10 to 50 ppm by weight per dry weight of the natural rubber, and/or wherein the amount of each metal ion of the one or more metal ions in the marker blended into the natural rubber latex, the coagulated natural rubber product or the natural rubber is in the range of 5 to 25 ppm by weight per dry weight of the natural rubber.

22. The method of claim 1, wherein the type and concentration of each of the one or more metal ions of the marker in the marked natural rubber or in the marked cured rubber product is detectable by x-ray fluorescence (XRF).
